(19) United States
(12) Patent Application Publication
(10) Pub. No.: US 2026/0172298 A1
(43) Pub. Date: Jun. 18, 2026

(54) NETWORK SYSTEM, SERVICE MESH CONFIGURATION METHOD, STORAGE MEDIUM, AND ELECTRONIC DEVICE

(71) Applicant: CLOUD INTELLIGENCE ASSETS HOLDING (SINGAPORE) PRIVATE LIMITED, Singapore (SG)

(72) Inventors: Qian DENG, Beijing (CN); Geng REN, Hangzhou, Zhejiang (CN); Xiao TAN, Hangzhou, Zhejiang (CN)

(21) Appl. No.: 19/122,917

(22) PCT Filed: Oct. 9, 2023
(86) PCT No.: PCT/CN2023/123608

§ 371 Date: Apr. 21, 2025

(30) Foreign Application Priority Data
Oct. 21, 2022 (CN) 202211295217.0

(51) Int. Cl. H04L 41/04; H04L 67/10; H04L 67/12

(52) U.S. Cl. CPC H04L 41/04; H04L 67/10; H04L 67/12

(57) ABSTRACT

The present application provides a network system, a service mesh configuration method, a storage medium, and an electronic device. The network system includes: a central management and control device and at least one edge cloud node, where the central management and control device is deployed with a central control plane component, and each edge cloud node is deployed with a service mesh proxy component and at least one edge control plane component; the central control plane component is configured to generate proxy configuration information for a target edge cloud node according to configuration requirement description information, and issue the proxy configuration information to a resource scheduling cluster accessed by the target edge cloud node; and the edge control plane component is configured to manage at least one service mesh proxy component in an edge cloud node where the edge control plane component is located, and issue, by monitoring a resource scheduling cluster accessed by the edge cloud node where the edge control plane component is located, at least a part of monitored proxy configuration information to a service mesh proxy component managed by the edge control plane component.

### CROSS-REFERENCE TO RELATED APPLICATIONS

This application is a National Stage of International Application No. PCT/CN2023/123608, filed on Oct. 9, 2023, which claims priority to Chinese Patent Application No. 202211295217.0, filed to China National Intellectual Property Administration on Oct. 21, 2022 and entitled “NETWORK SYSTEM, SERVICE MESH CONFIGURATION METHOD, STORAGE MEDIUM, AND ELECTRONIC DEVICE”. The two applications are hereby incorporated by reference in their entireties.

### TECHNICAL FIELD

The present application relates to the field of edge cloud computing technologies and, in particular, to a network system, a service mesh configuration method, a storage medium, and an electronic device.

### BACKGROUND

A distributed edge cloud is a cloud computing platform built on an edge infrastructure based on core and edge computing capabilities of the cloud computing technologies. By performing network forwarding, storage, computation, intelligent data analysis and other works at an edge near a user, the distributed edge cloud can reduce the response delay and relieve pressure of the cloud.

Reliable interaction among instances deployed at edge cloud nodes may be implemented by using a service mesh. The service mesh includes a control plane component belonging to a control plane and a service mesh proxy component belonging to a data plane. The service mesh proxy component has a one-to-one correspondence with an instance. The control plane component is responsible for issuing information deployed by an application to the service mesh proxy component, such that the service mesh proxy component may accordingly effectuate data interaction among the respective instances.

In the related art, information deployed by all applications is monitored through a single group of control plane components deployed at a central network, and distributed to each service mesh proxy instance. However, as a network scale of the distributed edge cloud gradually increases, a service mesh model in the related art cannot meet requirements in a scenario of the distributed edge cloud.

### SUMMARY

In order to overcome problems in the related art, the present application provides a network system, a service mesh configuration method, a storage medium, and an electronic device.

According to a first aspect of the embodiments of the present application, a network system is provided, including: a central management and control device and at least one edge cloud node, where the central management and control device is deployed with a central control plane component, and each edge cloud node is deployed with a service mesh proxy component and at least one edge control plane component;
the central control plane component is configured to generate proxy configuration information for a target edge cloud node according to configuration requirement description information, and issue the proxy configuration information to a resource scheduling cluster accessed by the target edge cloud node; and
the edge control plane component is configured to manage at least one service mesh proxy component in an edge cloud node where the edge control plane component is located, and issue, by monitoring a resource scheduling cluster accessed by the edge cloud node where the edge control plane component is located, at least a part of monitored proxy configuration information to a service mesh proxy component managed by the edge control plane component.

According to a second aspect of the embodiments of the present application, a service mesh configuration method is provided, where the service mesh includes a central control plane component deployed in a central management and control device, a service mesh proxy component and at least one edge control plane component deployed in an edge cloud node, the edge control plane component is configured to manage at least one service mesh proxy component in an edge cloud node where the edge control plane component is located; and the method is applied to the central control plane component and includes:
generating proxy configuration information for a target edge cloud node according to configuration requirement description information; and
issuing the proxy configuration information to a resource scheduling cluster accessed by the target edge cloud node for the edge control plane component deployed on the target edge cloud node to issue, by monitoring the resource scheduling cluster, at least a part of monitored proxy configuration information to a service mesh proxy component managed by the edge control plane component.

According to a third aspect of the embodiments of the present application, a service mesh configuration method is provided, where the service mesh includes a central control plane component deployed in a central management and control device, a service mesh proxy component and at least one edge control plane component deployed in an edge cloud node, the edge control plane component is configured to manage at least one service mesh proxy component in an edge cloud node where the edge control plane component is located; the method is applied to any edge control plane component and includes:
monitoring a resource scheduling cluster accessed by an edge cloud node where the any edge control plane component is located; and
issuing at least a part of monitored proxy configuration information to a service mesh proxy component managed by the any edge control plane component, wherein the proxy configuration information is generated by the central control plane component according to configuration requirement description information and issued to a resource scheduling cluster accessed by a target edge cloud node corresponding to the configuration requirement description information.

According to a fourth aspect of the embodiments of the present application, an electronic device is provided, including:
a processor; and a memory, configured to store instructions which are executable by the processor; where the processor is configured to implement steps of the method according to the second aspect or the third aspect.

According to a fifth aspect of the embodiments of the present application, provided a computer-readable storage medium is provided, where executable instructions are stored on the computer-readable storage medium; the instructions, when executed by a processor, implement steps of the method according to the second aspect or the third aspect.

Based on the above embodiments of the present application, it can be seen that, in the present application, by descending and deploying a configuration information issuing component originally deployed in a center in an edge cloud node, the interaction between the edge cloud node and the center side is reduced, the autonomy of the edge cloud node is implemented, and the response delay is reduced. Meanwhile, it is ensured that each edge cloud node is deployed with a corresponding edge control plane component, that is, a one-to-many connection relationship (the configuration information issuing component is connected to all service mesh proxy components) in the related art is adjusted to a many-to-many connection relationship (each edge control plane component is connected to a service mesh proxy component corresponding to the edge cloud node where the edge control plane component is located), there is no limitation on a scale of a cluster caused by the limited management capability of a single configuration information issuing component. Thus, the limitation on the scale of the cluster is eliminated, and the scale of the cluster is further expanded.

In addition, the proxy configuration information is selectively issued to the resource scheduling cluster by the central control plane component, the proxy configuration information is selectively issued to the service mesh proxy component by the edge control plane component, or the above two issuances are selectively performed at the same time. Compared with a globally undifferentiated issuing manner in the related art, the probability that useless proxy configuration information is issued to the service mesh proxy component is reduced or avoided, thereby avoiding a waste of system resources.

It should be understood that, both the foregoing general description and the following detailed description are only exemplary and explanatory and do not constitute a limitation of the present application.

### BRIEF DESCRIPTION OF DRAWINGS

The accompanying drawings herein, which are incorporated and form part of the present application, illustrate embodiments consistent with the present application and together with the present application, serve to explain principles of the present application.

FIG. 1 is a schematic diagram of an architecture of a distributed edge cloud according to an exemplary embodiment of the present application.

FIG. 2 is a schematic diagram of a service mesh in an edge cloud scenario according to an exemplary embodiment of the present application.

FIG. 3 is a schematic diagram of a system architecture of a network system according to an exemplary embodiment of the present application.

FIG. 4 is a flowchart of a service mesh configuration method according to an exemplary embodiment of the present application.

FIG. 5 is a schematic module diagram of a central control plane component according to an exemplary embodiment of the present application.

FIG. 6 is a flowchart of a service mesh configuration method according to an exemplary embodiment of the present application.

FIG. 7 is a schematic diagram of a service discovery component according to an exemplary embodiment of the present application.

FIG. 8 is a schematic structural diagram of an electronic device according to an exemplary embodiment of the present application.

FIG. 9 is a block diagram of a service mesh configuration apparatus according to an exemplary embodiment of the present application.

FIG. 10 is a block diagram of a service mesh configuration apparatus according to an exemplary embodiment of the present application.

### DESCRIPTION OF EMBODIMENTS

Exemplary embodiments will be described in detail, with examples shown in the accompanying drawings. With regard to the description related to the accompanying drawings, unless stated otherwise, the same numbering in different drawings may represent the same or similar elements. The embodiments described in the following exemplary embodiments do not represent all embodiments consistent with one or more embodiments of the present application. On the contrary, they are merely examples of apparatuses and methods consistent with some aspects of one or more embodiments of the present application.

It should be noted that, in other embodiments, steps of the corresponding method are not necessarily executed according to the order shown and described in the present application. In some other embodiments, the methods may include more or less steps than those described in the present application. In addition, a single step described in the present application may be divided into a plurality of steps described in other embodiments. While multiple steps described in the present application may also be combined into a single step for description in other embodiments. It should be understood that although the terms first, second, third, etc., may be employed in the present application to describe various information, the information should not be limited by these terms. These terms are only used to distinguish the same type of information from each other. For example, first information may also be referred to as second information, and similarly, the second information may also be referred to as the first information, without departing from the scope of the present application. The word “if” as used herein may be construed as “when . . . ” or “in a case that . . . ” or “in response to . . . determining” which depends on the context.

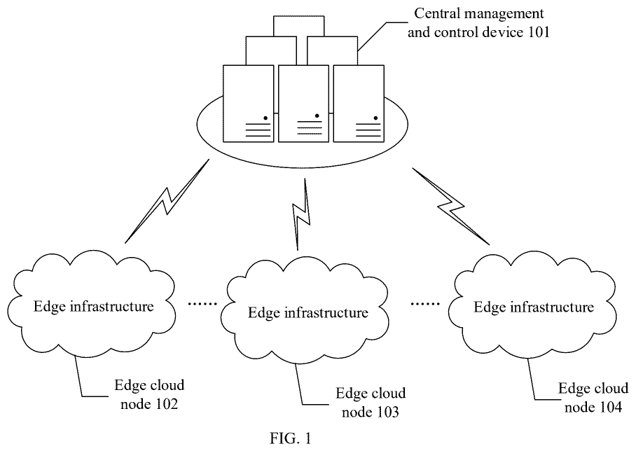

A distributed edge cloud is a cloud computing platform built on an edge infrastructure based on core and edge computing capabilities of the cloud computing technologies. By performing network forwarding, storage, computation, intelligent data analysis and other works at an edge near a user, the distributed edge cloud can reduce the response delay and relieve pressure of the cloud. In order to understand an architecture of the distributed edge cloud computing more visually, reference may be made to FIG. 1. FIG. 1 is a schematic diagram of an architecture of a distributed edge cloud according to an exemplary embodiment of the present application. The architecture of the distributed edge cloud may include a central management and control device 101 and a plurality of edge cloud nodes (e.g., an edge cloud node 102, an edge cloud node 103 and an edge cloud node 104). An edge cloud is a relative concept. The edge cloud refers to a cloud computing platform relatively close to a terminal. In other words, different from a central cloud or a traditional cloud computing platform, the central cloud or the traditional cloud computing platform may include a data center with a resource scale and a centralized location, while the edge cloud node covers a wider network range, and therefore has a characteristic of being closer to the terminal. A resource scale of a single edge cloud node is small, but the number of edge cloud nodes is large, and a plurality of edge cloud nodes form a component part of the edge cloud.

The distributed edge cloud includes at least one edge cloud node (e.g., the edge cloud node 102, the edge cloud node 103, and the edge cloud node 104). Each edge cloud node includes a series of edge infrastructures including, but not limited to, an edge device and a corresponding network environment, etc., such as a distributed data center (DC), a wireless room or cluster, communication network of operators, a core network device, a base station, an edge gateway, a home gateway, a computing device or a storage device, etc. It should be noted that locations, capabilities, and the included infrastructures of different edge cloud nodes may be the same or different.

The central management and control device 101 takes an edge cloud node (for example, the edge cloud node 102, the edge cloud node 103, and the edge cloud node 104) as a management and control object, to perform unified management and control on at least one edge cloud node in a network system in aspects such as resource scheduling, mirror image management, instance management, operation and maintenance, network, security and the like, so that a cloud computing service can be processed by edge cloud nodes. In the deployment implementation, the central management and control device 101 may be deployed in one or more cloud computing data centers, or may be deployed in one or more traditional data centers. The central management and control device 101 may also form an edge cloud together with the at least one edge cloud node managed and controlled by the central management and control device 101.

In this embodiment, the edge cloud, a central network such as the central cloud, the traditional cloud computing platform, etc., and a terminal may form a “cloud-edge-terminal three-entity collaboration” network architecture. In this network architecture, tasks, such as network forwarding, storage, computation, intelligent data analysis and the like, may be processed by the edge cloud nodes (for example, the edge cloud node 102, the edge cloud node 103, and the edge cloud node 104). Since the edge cloud nodes are closer to the terminal, the response delay can be reduced, and the pressure of the central cloud or the traditional cloud computing platform can be reduced, thereby reducing the bandwidth cost.

An edge cloud node can provide various resources to outside, for example, computing resources such as a central processing unit (CPU) and a graphics processing unit (GPU), storage resources such as a memory and a hard disk, network resources such as a bandwidth, etc. In addition, the edge cloud node 102 may also create a corresponding instance based on a mirror image, and provide various cloud computing services to the outside through the instance. The mirror image refers to create a basic file required by an instance in an edge cloud node, and may be, for example, providing a mirror image file, such as an operating system, an application, or an operation configuration, etc., required by a cloud computing service for a user. The basic file may be a file that meets deployment and computation requirements of an edge cloud node and is manufactured according to a specific series of files in a certain format. In addition, the mirror image is in various forms, and may be a virtual machine (VM) mirror image file, a container (Docker) mirror image file, or various types of application packaging files. The form of the mirror image may be related to virtualization technologies that needs to be used by the cloud computing service, which is not limited in this embodiment. Corresponding to the image, the implementation form of the instance may be a virtual machine, a container, an application program, and the like.

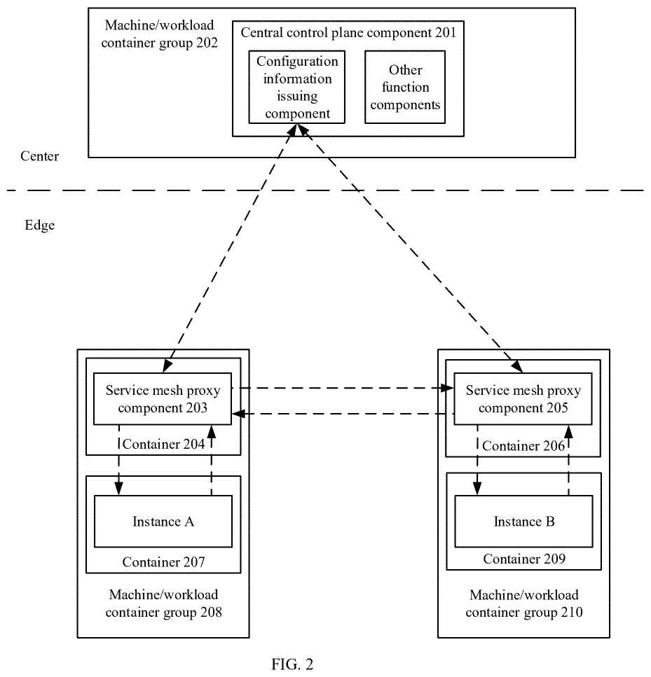

With regard to the instances deployed in the edge cloud node, especially when there are a large number of instances, a communication topology in the entire network system will be extremely complex, and thus communication among the instances can be realized through a service mesh. The service mesh refers to a configurable infrastructure layer for microservice application management, commonly used to describe services (e.g., microservices) that constitute applications and interactions among the various services. The service mesh may provide functions, such as intelligent routing (e.g., Canary Releases, A/B testing, etc.), timeout and retry, circuit breaker, fault injection, traffic quota, blacklist and whitelist, and the like, for applications or services. However, the implementation of these functions may depend on coordination processing between two types of planes (a control plane and a data plane) of the service mesh. The control plane is a group of services running in a dedicated namespace, and these services are used for completing some control management functions, such as aggregating telemetry data, providing an application programming interface (API) to users, providing control data to the data plane, etc. The data plane consists of a series of transparent proxies running along each service instance. As shown in FIG. 2, FIG. 2 is a schematic diagram of a service mesh in an edge cloud scenario according to an exemplary embodiment of the present application. A service mesh proxy component may forward a request to be sent to the service mesh or a request sent by the service mesh. A request corresponding to each micro-service in the service mesh may pass through the service mesh proxy, so that traffic no longer enters the service, thereby implementing decoupling of the traffic and the service. Proxy configuration information in the service mesh proxy component is used to enable the service mesh to correctly proxy service traffic, thereby implementing service interworking and service management. Specifically, the proxy configuration information may be issued to each service mesh proxy by using the centrally deployed configuration information issuing component shown in FIG. 2. Taking a configurable open-source service mesh Istio as an example, the configuration information issuing component is a Pilot component, that is, the Pilot component issues proxy configuration information to each service mesh proxy component.

As shown in FIG. 2, a microservice may include an instance A and an instance B. The instance A and the instance B form a functional application layer of the service mesh. In an implementation, instances A and B may run in a machine/workload container group (Pod) in a form of a container or a process, such as in Pod 207 and Pod 209.

In an implementation, the instance A may be a goods query service and the instance B may be a goods ordering service.

As shown in FIG. 2, the instance A and a service mesh proxy component 203 coexist in a machine/workload container group 208, and the instance B and a service mesh proxy component 205 coexist in a machine/workload container group 210. The service mesh proxy component 203 and 205 form a data plane of the service mesh. The service mesh proxy components 203 and 205 run in a form of a container/process 204 and a container/process 206 respectively, bidirectional communication can be performed between the service mesh proxy component 203 and the instance A, and bidirectional communication can be performed between the service mesh proxy component 205 and the instance B. In addition, bidirectional communication may also be performed between the service mesh proxy component 203 and the service mesh proxy component 205. It should be noted that, the machine/the workload container group 208 and the machine/the workload container group 210 shown in FIG. 2 may be deployed at the same edge cloud node, or may also be deployed at different edge cloud nodes, so that according to actual requirements, interaction may be implemented between instances deployed in the edge cloud node, interaction may also be implemented between instances across nodes, which may be determined according to actual requirements.

In an implementation, all traffic for the instance A is routed through the service mesh proxy component 203 to an appropriate destination, and all network traffic for the instance B is routed through the service mesh proxy component 205 to an appropriate destination. It should be noted that, the network traffic mentioned herein includes, but is not limited to, forms such as a hyper text transfer protocol (HTTP), a representational state transfer (REST), a remote procedure call (RPC, such as g RPC), and a remote dictionary server (Redis), etc.

In an implementation, a function of extending the data plane can be achieved by writing a custom filter for proxy (Envoy) in the service mesh, and the proxy configuration information is used to enable the service mesh to correctly proxy service traffic, so as to implement service interworking and service management. The service mesh proxy component 203 and the service mesh proxy component 205 may be configured to perform at least one of the following functions: service discovery, health checking, routing, load balancing, authentication and authorization, and observability.

As shown in FIG. 2, the service mesh also includes a control plane. The control plane may be a group of services running in a dedicated namespace. These services are hosted by a central control plane component 201 in a machine/workload container group (Machine/Pod) 202. As shown in FIG. 2, the central control plane component 201 is in bi-directional communication with the service mesh proxy component 203 and the service mesh proxy component 205. The central control plane component 201 is configured to perform some control and management functions. For example, the central control plane component 201 receives telemetry data transmitted by the service mesh proxy component 203 and the service mesh proxy component 205, and may further aggregate the telemetry data. These services, the central control plane component 201 may also provide a user-oriented Application Programming Interface (API) to facilitate manipulation of network behavior, and provide configuration data to the service mesh proxy component 203 and the service mesh proxy component 205, and the like.

It can be seen from FIG. 2 that in the related art, in order to implement service interworking and service management as stated above, a centrally deployed configuration information issuing component needs to issue proxy configuration information about a service mesh to each service mesh proxy component (such as issuing the same to the service mesh proxy component 203 and the service mesh proxy component 205). Therefore, on the one hand, the edge cloud node needs to maintain interaction with the central cloud, which causes that the response delay cannot be effectively reduced. Furthermore, in a case that the network environment between the cloud and the edge is a high-latency environment of a weak network, the response delay is further amplified, making users perceptible. On the other hand, the centrally deployed configuration information issuing component needs to be responsible for managing all service mesh proxy components. However, the management capability of the configuration information issuing component is limited, which limits the overall number of the service mesh proxy components, thereby indirectly limiting the number of the accessed edge cloud nodes. Thus, a cluster scale of the edge cloud nodes cannot be expanded infinitely. Furthermore, the configuration information issuing component can only implement configuration management from a global dimension, i.e., the configuration information issuing component issues information configured by each application to all the service mesh proxy components. In fact, each service mesh proxy component only needs to focus on the proxy configuration information corresponding to the location where the service mesh proxy component is located. Accordingly, an undifferentiated issuing manner by the configuration information issuing component causes a waste of resources.

Therefore, in order to solve the above problem, the present application provides an improved network system and an improved service mesh configuration method, which correspondingly improves the network system and configuration logic of a service mesh. The method is described in detail below with reference to embodiments.

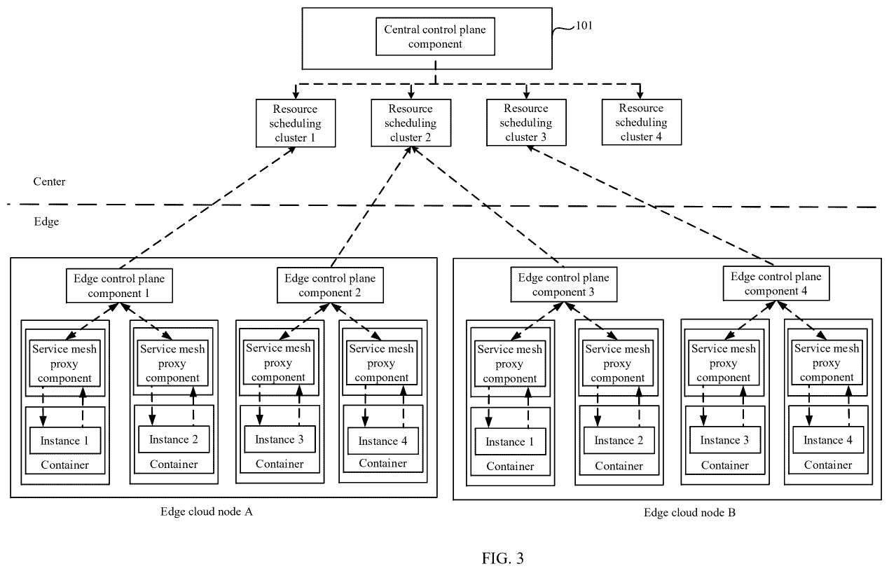

As shown in FIG. 3, FIG. 3 is a schematic diagram of a system architecture of a network system according to an exemplary embodiment of the present application. The central management and control device 101 may be deployed with a central control plane component, and each edge cloud node is deployed with a service mesh proxy component and at least one edge control plane component. The service mesh proxy components have a one-to-one correspondence with instances, so as to ensure that each instance has a service mesh proxy component connected thereto. In this way, the service mesh proxy component may proxy network traffic, thereby implementing service interworking and service management as described above.

The central control plane component may be configured to generate proxy configuration information for a target edge cloud node according to configuration requirement description information, and issue the proxy configuration information to a resource scheduling cluster accessed by the target edge cloud node.

The resource scheduling cluster may be a Kubernetes cluster. Kubernetes is a transplantable and extensible open-source platform, uses declarative configuration, and automatically execute management of a containerized application according to configuration information. Based on the Kubernetes cluster, instances running on the edge cloud nodes can be efficiently managed. Taking the Kubernetes cluster as an example, a corresponding cluster function component is deployed in the center, and accessing the resource scheduling cluster may be understood as establishing a connection with the cluster function component deployed in the foregoing center.

Generally, only a unique resource scheduling cluster may be divided, so that all edge cloud nodes access the unique resource scheduling cluster, thereby implementing unified management. However, in some scenarios, for reasons such as actual requirements, a plurality of resource scheduling clusters may also be divided, and a plurality of edge cloud nodes are split into different resource scheduling clusters so as to control the number of the edge cloud nodes accessed by each resource scheduling cluster. As shown in FIG. 3, it can be divided to have resource scheduling cluster 1, resource scheduling cluster 2, resource scheduling cluster 3 and resource scheduling cluster 4. Of course, supposing that the number of the edge cloud nodes is small, it may also be selected not to split the edge cloud nodes and access a plurality of different resource scheduling clusters. That is, all nodes may access only one resource scheduling cluster, which is not limited in the present application. It should be noted that the relationship between the edge cloud nodes and the resource scheduling clusters may be divided from node dimensions. As described above, the entire edge cloud node is divided into a corresponding resource scheduling cluster. However, resources on the edge cloud node may be further divided. For example, resources of the same edge cloud node are divided into a plurality of parts (such as a first part and a second part), where different parts of the same edge cloud node may be divided into corresponding resource scheduling clusters. For example, the first part of the same edge cloud node may be divided into the resource scheduling cluster 1, and the second part may be divided into the resource scheduling cluster 2. Then, an instance created based on the first part may be considered as belonging to the resource scheduling cluster 1, and an instance created based on the second part may be considered as belonging to the resource scheduling cluster 2. That is, as shown in FIG. 3, instance 1 and instance 2 of an edge cloud node A may be considered as belonging to the resource scheduling cluster 1, instance 3 and example 4 may be considered as belonging to the resource scheduling cluster 2, and then it may be considered that the edge cloud node A belongs to both the resource scheduling cluster 1 and the resource scheduling cluster 2.

The edge control plane component may be configured to manage at least one service mesh proxy component in an edge cloud node where the edge control plane component is located, and issue, by monitoring a resource scheduling cluster accessed by the edge cloud node where the edge control plane component is located, at least a part of monitored proxy configuration information to a service mesh proxy component managed by the edge control plane component.

The function of the edge control plane component is mainly to issue the proxy configuration information as described above to the service mesh proxy component. However, different from the configuration information issuing component in the related art, the edge control plane component in the present application does not issue all the proxy configuration information blindly to the edge cloud nodes. The edge control plane component may identify monitored proxy configuration information, and issue the proxy configuration information meeting requirements to a service mesh proxy component managed by the edge control plane component. In this way, the service mesh proxy component does not receive useless proxy configuration information, so that the service mesh proxy component can directly use the received the received proxy configuration information without screening, and workload of the service mesh proxy component is reduced. It should be noted that, as described above, it is assumed that the central control plane component issues the generated proxy configuration information to a resource scheduling cluster determined among the multiple divided resource scheduling clusters in a targeted manner (the central control plane component selectively issues the proxy configuration information), in this case, the edge control plane component may also directly issue the monitored proxy configuration information to the service mesh proxy component managed by the edge control plane component without identification. Even so, compared with the globally undifferentiated issuing mode in the related art, the number of the proxy configuration information issued by the edge control plane component is also small, and the probability that useless proxy configuration information is issued to the service mesh proxy component can still be effectively reduced. Furthermore, the edge control plane component in the present application is functionally similar to the configuration information issuing component shown in FIG. 2, however, the deployment modes are different. In the present application, the configuration information issuing component with the original centralized deployment is descended and deployed in an edge cloud node, and the edge control plane component implements the issuing of the proxy configuration information, thereby realizing the autonomy of the edge cloud node. Therefore, the interaction steps between the edge cloud node and the center side are reduced, and the response delay is reduced.

In a case that one or more resource scheduling clusters exist, when the central control plane component issues proxy configuration information to a resource scheduling cluster accessed by a target edge cloud node, there may also exist a plurality of cases, and the plurality of cases will be introduced respectively in the present application below.

In an embodiment, there is only one resource scheduling cluster, that is, all edge cloud nodes in the network system belong to the same resource scheduling cluster. Accordingly, the target edge cloud node may be all the edge cloud nodes in the network system, and in this case, the central control plane component may issue the proxy configuration information to the resource scheduling cluster accessed by all the edge cloud nodes in the network system. Since there is only one resource scheduling cluster, the central control plane component may directly issue the generated proxy configuration information to the only one resource scheduling cluster. However, even if the central control plane component uses a directly issuing mode without screening, due to existence of the edge control plane component, the edge control plane component may monitor the resource scheduling cluster, so as to issue at least a part of the monitored proxy configuration information to a service mesh proxy component managed by the edge control plane component. That is, the edge control plane component may “take as necessary” such that the service mesh proxy component only receives proxy configuration information related to itself. The probability of useless proxy configuration information being issued to the service mesh proxy component is also avoided.

Alternatively, the target edge cloud node may be a specified edge cloud node, such as an edge cloud node selected by a tenant. Since there is only one resource scheduling cluster, that is, no matter whether the target edge cloud node is the edge cloud node 102 or the edge cloud node 103, it belongs to the only resource scheduling cluster. Therefore, the central control plane component only needs to issue the generated proxy configuration information to the only resource scheduling cluster. The edge control plane component monitors the resource scheduling cluster, so that the edge control plane component may determine, from a plurality pieces of proxy configuration information received by the resource scheduling cluster, whether there exists proxy configuration information corresponding to a node where the edge control plane component is located, and issue the determined proxy configuration information to the service mesh proxy component managed by the edge control plane component, so as to avoid the probability that useless proxy configuration information is issued to the service mesh proxy component.

In an embodiment, there are multiple divided resource scheduling clusters, that is, edge cloud nodes in the network system belong to the multiple resource scheduling clusters. Accordingly, as described above, the target edge cloud node may be all the edge cloud nodes in the network system. In this case, although there are multiple divided resource scheduling clusters, in order to reduce workload of the central control plane component, the central control plane component may still issue the generated proxy configuration information to resource scheduling clusters accessed by all the edge cloud nodes. That is, each resource scheduling cluster may receive the proxy configuration information generated by the central control plane component. Of course, the edge control plane component may monitor and screen the proxy configuration information, so as to ensure that the service mesh proxy component only receives the proxy configuration information corresponding to itself, thereby preventing useless proxy configuration information from being sent to the service mesh proxy component or reducing the occurrence probability of this situation.

Alternatively, as described above, the target edge cloud node may be a specified edge cloud node. The central control plane component may determine a resource scheduling cluster accessed by the specified edge cloud node, thereby issuing the generated proxy configuration information to a determined resource scheduling cluster. That is, the central control plane component issues the proxy configuration information in a targeted manner. The resource scheduling cluster only receives proxy configuration information for an edge cloud node to which the resource scheduling cluster itself belongs. In this way, the monitoring load of the edge control plane component can be reduced. Furthermore, the edge control plane component can issue at least a part of the monitored proxy configuration information to a service mesh proxy component managed by the edge control plane component. It is ensured that the service mesh proxy component only receives the proxy configuration information required by itself, thereby preventing useless proxy configuration information from being sent to the service mesh proxy component or reducing the occurrence probability of this situation.

It should be noted that, since the central control plane component has performed screening once (the proxy configuration information is issued to a corresponding resource scheduling cluster), the edge control plane component may also not perform the foregoing screening, but directly issues all monitored proxy configuration information to a corresponding service mesh proxy component. Even so, the service mesh proxy component will only receive the proxy configuration information of the resource scheduling cluster accessed by the edge cloud node where the service mesh proxy component is located. Therefore, the number of the configuration information issued by the service mesh proxy component is also smaller than the number of the configuration information globally issued without differences in the related art. The probability of useless proxy configuration information being issued to the service mesh proxy component is reduced.

Based on the architecture of the network system shown in FIG. 3, in the present application, by descending and deploying a configuration information issuing component originally deployed in a center in an edge cloud node, the interaction between the edge cloud node and the center side is reduced, the autonomy of the edge cloud node is implemented, and the response delay is reduced. Meanwhile, it is ensured that each edge cloud node is deployed with a corresponding edge control plane component, that is, a one-to-many connection relationship (the configuration information issuing component is connected to all service mesh proxy components) in the related art is adjusted to a many-to-many connection relationship (each edge control plane component is connected to a service mesh proxy component corresponding to the edge cloud node where the edge control plane component is located), there is no limitation on a scale of a cluster caused by the limited management capability of a single configuration information issuing component as described above. Thus, the limitation on the scale of the cluster is eliminated, and the scale of the cluster is further expanded.

In addition, the proxy configuration information is selectively issued to the resource scheduling cluster by the central control plane component, the proxy configuration information is selectively issued to the service mesh proxy component by the edge control plane component, or the two issuances are selectively performed at the same time. Compared with a globally undifferentiated issuing manner in the related art, the probability that useless proxy configuration information is issued to the service mesh proxy component is reduced or avoided, thereby avoiding a waste of system resources.

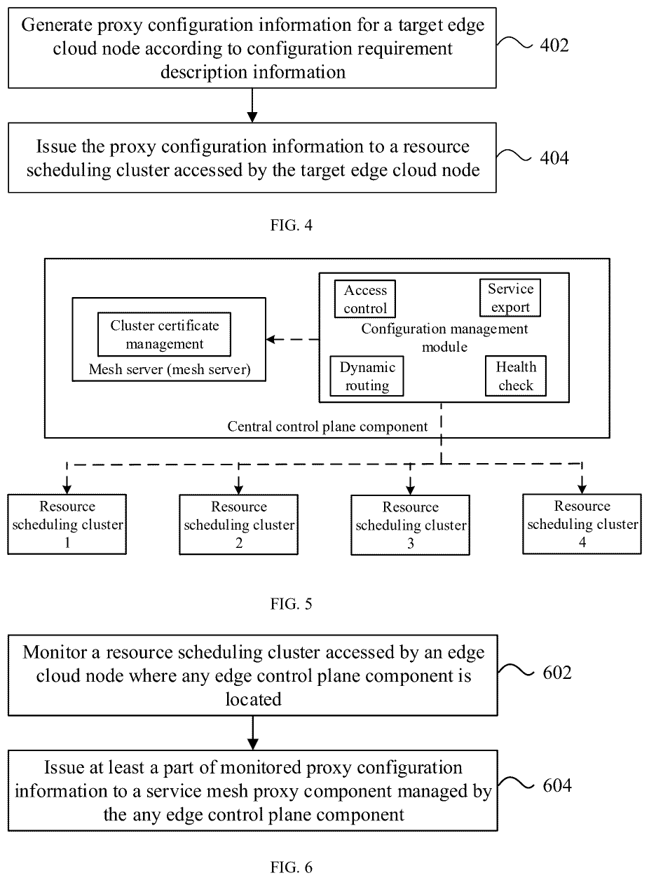

FIG. 4 is a flowchart of a service mesh configuration method according to an exemplary embodiment of this present application. The service mesh includes a central control plane component deployed in a central management and control device, a service mesh proxy component and at least one edge control plane component deployed in an edge cloud node, the above edge control plane component is configured to manage at least one service mesh proxy component in an edge cloud node where the edge control plane component is located. The method is applied to the central control plane component, and may specifically include the following steps.

Step 402: generate proxy configuration information for a target edge cloud node according to configuration requirement description information.

The configuration requirement description information may be sent by a tenant. For example, assuming that tenant A deploys instance 1 at edge cloud node A, when the instance 1 needs to be configured and updated, tenant A may send corresponding configuration requirement description information, so that the central control plane component generates corresponding proxy configuration information.

When instances are deployed in an edge cloud node, a node may be used as a unit to divide a corresponding namespace, and when a same application is deployed at different nodes, the instances may belong to different namespaces, thereby implementing resource isolation. For example, taking FIG. 3 as an example, a namespace corresponding to the edge cloud node A may be namespace1, a namespace corresponding to the edge cloud node B may be namespace2, and the instances between different namespaces are isolated from each other, so that the instance in the edge cloud node A cannot access the instance in the edge cloud node B, thereby implementing the resource isolation. Of course, in a deployment process of an instance, tenant information, node information, an application name, and the like corresponding to the application may be added to a Pod (container) label of the instance, so as to distinguish each container (Pod). After the instance is deployed and run, a corresponding service may be provided to the outside.

The proxy configuration information refers to configuration information generated by the central control plane component, so as to enable a service mesh to correctly proxy service traffic, thereby implementing service interworking and service management, and is applied to the service mesh proxy component. Specifically, the proxy configuration information may include at least one piece of related information such as a Pod (container), a gateway, a destination-rule, and a virtual-service. Of course, according to an actual application, specific content of the proxy configuration information may also be adjusted adaptively, which is not necessarily limited to the foregoing types.

In order to ensure secure and reliable writing of the proxy configuration information, in an embodiment, a corresponding verification step may be added to the writing of the proxy configuration information. That is, the central control plane component maintains an authentication certificate of a resource cluster, and based on the authentication certificate, the writing of the proxy configuration information needs to obtain a certificate of a resource scheduling cluster (such as a Kubernetes cluster) to which a corresponding edge cloud node belongs. Thus, the central control plane component may generate, according to the resource scheduling cluster accessed by the target edge cloud node, proxy configuration information comprising an authentication certificate of a corresponding resource scheduling cluster for the resource scheduling cluster receiving the proxy configuration information to perform authentication based on the authentication certificate, which ensures that the writing of the proxy configuration information is secure and reliable, and malicious writing is avoided.

Based on the authentication of the certificate, the central control plane component may be divided into two modules. As shown in FIG. 5, a mesh server module and a configuration management module are specifically included. The mesh server module maintains the authentication certificate of the resource cluster. When the configuration management module needs to generate the proxy configuration information, the mesh service module provides a corresponding certificate. For example, it is assumed that proxy configuration information for an edge cloud node A needs to be generated, and this edge cloud node belongs to the resource scheduling cluster 1, therefore, an authentication certificate corresponding to the resource scheduling cluster 1 needs to be obtained, so as to generate corresponding proxy configuration information. Access control, service export, dynamic routing, and health check shown in FIG. 5 are functions that may be specifically executed by the service mesh proxy component after the proxy configuration information is applied as described above. Of course, other functions may also be included, and the present application is not limited thereto.

Step 404: issue the proxy configuration information to a resource scheduling cluster accessed by the target edge cloud node for the edge control plane component deployed on the target edge cloud node to issue, by monitoring the resource scheduling cluster, at least a part of monitored proxy configuration information to a service mesh proxy component managed by the edge control plane component.

As described above, when there are a large number of edge cloud nodes, the edge cloud nodes may be divided into different resource clusters. After generating the proxy configuration information, the central control plane component may also issue the proxy configuration information to a corresponding cluster. In view of this, the central control plane component may maintain a preset corresponding relationship, the preset corresponding relationship includes a corresponding relationship between an edge cloud node and a resource scheduling cluster accessed by the edge cloud node. Specifically, the corresponding relationship may be embodied in a form of Table 1.

TABLE 1

| Edge cloud node | Accessed resource scheduling cluster |
|---|---|
| Edge cloud node A | Resource scheduling cluster 1 |
| Edge cloud node B | Resource scheduling cluster 2 |

In this case, the central control plane component may acquire a node identifier of the target edge cloud node carried in the configuration requirement description information, determining the resource scheduling cluster accessed by the target edge cloud node according to the preset corresponding relationship, and issuing the proxy configuration information to the determined resource scheduling cluster. For example, if the node identifier of the target edge cloud node carried in the configuration requirement description information is represented as the edge cloud node A, it may be determined that the resource scheduling cluster is 1 according to the corresponding relationship shown in Table 1. Therefore, the generated proxy configuration information may be issued to the resource scheduling cluster 1. The corresponding relationship may be maintained in a mesh service module as shown in FIG. 5.

It should be noted that, a same edge cloud node may be deployed with a plurality of instances. As shown in FIG. 3, the edge cloud node A may be deployed with an instance 1, an instance 2, an instance 3, and an instance 4. As described above, not only the entire edge cloud node may be divided into a corresponding resource scheduling cluster, but also resources on the edge cloud node may be further divided. For example, resources of the edge cloud node A are divided into a plurality of parts (such as a first part and a second part). The first part may be divided into the resource scheduling cluster 1, and the second portion may be divided into the resource scheduling cluster 2. Then, instance 1 and instance 2 created based on the first part may be considered to belong to the resource scheduling cluster 1, instance 3 and instance 4 created based on the second part may be considered to belong to the resource scheduling cluster 2. That is, as shown in FIG. 3, the edge cloud node A may also be considered to belong to both the resource scheduling cluster 1 and the resource scheduling cluster 2. If the corresponding relationship shown in Table 1 is still used, the central control plane component may issue the proxy configuration information generated for instance 1 to resource scheduling cluster 1 and resource scheduling cluster 2 at the same time. Hence, in order to avoid the above situation, a corresponding instance identifier, such as an application name and the like, may be added to the above corresponding relationship, so as to more accurately determine a corresponding resource scheduling cluster, as shown in Table 2.

TABLE 2

| Instance identifier | Edge cloud node | Resource scheduling cluster |
|---|---|---|
| Instance 1 | Edge cloud node A | Resource scheduling cluster 1 |
| Instance 2 | Edge cloud node A | Resource scheduling cluster 1 |
| Instance 3 | Edge cloud node A | Resource scheduling cluster 2 |
| Instance 4 | Edge cloud node A | Resource scheduling cluster 2 |

For example, when needing to update proxy configuration information of instance 1, tenant A may send corresponding configuration requirement description information including a corresponding instance identifier, so that the central control plane component may determine, according to the preset corresponding relationship as shown in Table 2, a corresponding resource scheduling cluster being the resource scheduling cluster 1. The central control plane component may also correspondingly issue the generated proxy configuration information to the determined resource scheduling cluster 1. The issuance of proxy configuration information to both resource scheduling cluster 1 and resource scheduling cluster 2 at the same time as described above will not occur.

Actually, which instances are specifically deployed depends on a tenant, that is, tenant A may select to deploy instance 1 and instance 2, and tenant B may select to deploy instance 3 and instance 4, that is to say, a corresponding relationship exists between an instance and a tenant. Therefore, the instance 1 and the instance 2 recorded in Table 2 may both belong to the tenant A, and by using the corresponding relationship between the instance and the tenant, storage space of the mesh service module can be saved, and the corresponding relationship shown in Table 3 is obtained.

TABLE 3

| Tenant | Edge cloud node | Accessed resource scheduling cluster |
|---|---|---|
| Tenant A | Edge cloud node A | Resource scheduling cluster 1 |
| Tenant B | Edge cloud node A | Resource scheduling cluster 2 |

Of course, a plurality of instances deployed by the same tenant may also belong to different resource scheduling clusters respectively, depending on which resource scheduling cluster a resource used for deploying a corresponding instance belongs to. For example, when the tenant A deploys an instance on the edge cloud node A, if a resource used for deploying the instance 1 belongs to resource scheduling cluster 1, and a resource used for deploying the instance 2 belongs to resource scheduling cluster 2. After the deployment is completed, the instance 1 will correspond to the resource scheduling cluster 1, the instance 2 will correspond to the resource scheduling cluster 2. Then, resource scheduling clusters corresponding to tenant A in Table 3 may include the resource scheduling cluster 1 and the resource scheduling cluster 2.

In a case that the edge cloud node includes multiple copies of resources corresponding to multiple tenants, and each copy of resources is respectively accessed to different resource scheduling clusters, the preset corresponding relationship further includes a corresponding relationship between a tenant and a resource scheduling cluster. The central control plane component is specifically configured to: acquire the node identifier of the target edge cloud node carried in the configuration requirement description information and information about a target tenant that sends the configuration requirement description information; determine, according to the preset corresponding relationship, the resource scheduling cluster accessed by the target edge cloud node and corresponding to the target tenant; and issue the proxy configuration information to the determined resource scheduling cluster. Taking Table 3 as an example, it is assumed that a node identifier carried in the requirement description information represents the edge cloud node A, and the target tenant that sends the configuration requirement description information is tenant A, it may be determined in this case that the generated proxy configuration information is sent to resource scheduling cluster 1. Such phenomenon that the proxy configuration information is sent to both resource scheduling cluster 1 and resource scheduling cluster 2 as described above would be avoided. Thus, the proxy configuration information may be issued accurately.

In an embodiment, the target edge cloud node may be all the edge cloud nodes in a network system, and the central control plane component may issue the proxy configuration information to a resource scheduling cluster accessed by all the edge cloud nodes in the network system. In other words, in this case, the central control plane component does not need to determine the cluster to which the proxy configuration information is issued, but directly issues the proxy configuration information to the resource scheduling cluster accessed by all edge cloud nodes. As described above, the proxy configuration information may be screened depending on the edge control plane component to avoid the probability of the service mesh proxy component receiving useless proxy configuration information.

It should be emphasized that, the scope specifically covered by “at least a part of” in “issuing at least a part of monitored proxy configuration information to a service mesh proxy component managed by the edge control plane component” described in the present application may be determined according to whether the central control plane component performs screening and issues the same to a corresponding resource scheduling cluster. It is assumed that the central control plane component does not perform screening, but issues the proxy configuration information to all the resource scheduling clusters, the edge control plane component may screen the proxy configuration information according to a node identifier. In this case, the screened proxy configuration information matching the node identifier is the at least a part of the proxy configuration information, so as to avoid the probability of the service mesh proxy component receiving useless proxy configuration information. Assuming that the central control plane component performs screening, the proxy configuration information is issued to the resource scheduling cluster in a targeted manner, then the edge control plane component may still screen the proxy configuration information according to the node identifier, thereby avoiding the probability of the service mesh proxy component receiving useless proxy configuration information. Or, the edge control plane component may directly issue all proxy configuration information received by the determined resource scheduling cluster to the service mesh proxy component without screening, so as to reduce the probability of the service mesh proxy component receiving useless proxy configuration information (because the service mesh proxy component will not receive proxy configuration information of a resource scheduling cluster other than the determined resource scheduling cluster).

FIG. 6 is a flowchart of a service mesh configuration method according to an exemplary embodiment of the present application. The service mesh may include a central control plane component deployed in a central management and control device, a service mesh proxy component and at least one edge control plane component deployed in an edge cloud node, the edge control plane component is configured to manage at least one service mesh proxy component in an edge cloud node where the edge control plane component is located. The method is applied to any edge control plane component, and specifically includes the following steps.

Step 602: monitor a resource scheduling cluster accessed by an edge cloud node where the any edge control plane component is located.

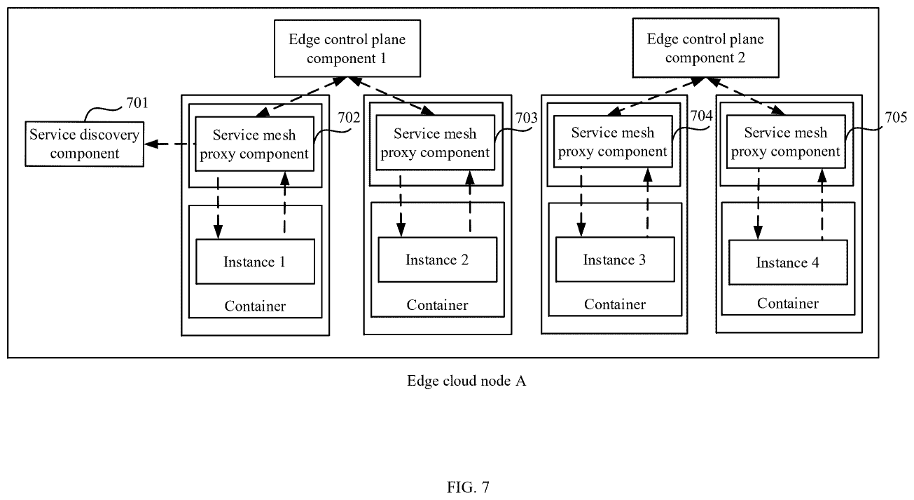

Implementation of the monitoring may depend on long connections between edge control plane components and resource scheduling clusters. The edge control plane component needs to be connected to at least one service mesh proxy component, and the specific connection may depend on a service discovery component (Core DNS). As shown in FIG. 7, the service discovery component 701 is configured to manage an address of the edge control plane component deployed in an edge cloud node where the service discovery component 701 is located. For example, the service discovery component 701 manages an address of an edge control plane component 1 and an address of an edge control plane component 2. Thus, after a service mesh proxy component (such as a service mesh proxy component 702, a service mesh proxy component 703, a service mesh proxy component 704 or a service mesh proxy component 705) is started, the service mesh proxy component may obtain, by querying the service discovery component 701, an address of an edge control plane component had been deployed in the edge cloud node where the service mesh proxy component is located, and establish a connection with an edge control plane component corresponding to any address. The address may be a back-end IP address of an edge control plane component, so that the service mesh proxy component may query, through the service discovery component, a back-end IP address of an edge control plane component deployed in the node, and establish a connection with one edge control plane component thereof. For example, assuming that after the service mesh proxy component 702 is started, the service mesh proxy component 702 may obtain a back-end IP address of the edge control plane component 1 through querying the service discovery component 701, and establish a connection with the edge control plane component 1. In a case where there is a plurality of edge control plane components, a specific connection manner of the service mesh proxy component may be a random connection. For example, a random number is used to randomly determine an edge control plane component from the plurality of edge control plane components, and then a connection is established with the edge control plane component. Of course, the edge control plane component that is desired to be connected may also be selected in other manners, for example, by selecting an IP address with a maximum value or a minimum value, which is not limited in the present application. Assuming that only one edge control plane component is deployed in the edge cloud node, the service mesh proxy component may directly establish a connection with the only edge control plane component. Connection manners of other service mesh proxy components (such as the service mesh proxy component 703, the service mesh proxy component 704, and the service mesh proxy component 705) are similar to that described above, and details are not repeatedly described herein.

Step 604: issue at least a part of monitored proxy configuration information to a service mesh proxy component managed by the any edge control plane component, where the proxy configuration information is generated by the central control plane component according to configuration requirement description information and issued to a resource scheduling cluster accessed by a target edge cloud node corresponding to the configuration requirement description information.

In an embodiment, the proxy configuration information may include a node identifier of the target edge cloud node, and the edge control plane component may select, according to the node identifier of the edge cloud node where the edge control plane component is located, proxy configuration information related to the edge cloud node where the edge control plane component is located from the monitored configuration information, and issue the selected proxy configuration information to at least one service mesh proxy component managed by the edge control plane component. In other words, the edge control plane component only issues the updated proxy configuration information corresponding to its own node to a corresponding service mesh proxy component, and does not issue all the proxy configuration information of the whole cluster to the service mesh proxy component, thereby implementing isolation and configuration management based on a node dimension, and avoiding resource waste caused by issuing all the configuration information. Specifically, the edge control plane component may include a selector, and the selector may screen the proxy configuration information received by the resource scheduling cluster based on a predefined rule (for example, information about a node identifier carried in the proxy configuration information matches a node identifier of the edge cloud node where the edge control plane component is located). Thus, the edge control plane component may determine the proxy configuration information corresponding to its own node.

After obtaining the updated proxy configuration information issued by the edge control plane component, the service mesh proxy component may update its proxy configuration information, thereby implementing service interworking and service management. For example, the updated proxy configuration information may enable instance 1 to expose port 1111 via the service mesh proxy component and forward network traffic to port 2222 of instance 2, and in the forwarding process, a polled load balancing strategy is used, and meanwhile health check is performed on port 3333 of instance 2.

It can be seen from the foregoing embodiments that, in the present application, by descending and deploying a proxy configuration information issuing component originally deployed in a center in an edge cloud node, the interaction between the edge cloud node and the center side is reduced, the autonomy of the edge cloud node is implemented, and the response delay is reduced. Meanwhile, it is ensured that each edge cloud node is deployed with a corresponding edge control plane component, that is, a one-to-many connection relationship (the configuration information issuing component is connected to all service mesh proxy components) in the related art is adjusted to a many-to-many connection relationship (each edge control plane component is connected to a service mesh proxy component corresponding to the edge cloud node where the edge control plane component is located), there is no limitation on a scale of a cluster caused by the limited management capability of a single configuration information issuing component as described above. Thus, the limitation on the scale of the cluster is eliminated, and the scale of the cluster is further expanded.

In addition, the proxy configuration information is selectively issued to the resource scheduling cluster by the central control plane component, the proxy configuration information is selectively issued to the service mesh proxy component by the edge control plane component, or the two issuances are selectively performed at the same time. Compared with a globally undifferentiated issuing manner in the related art, the probability that useless proxy configuration information is issued to the service mesh proxy component is reduced or avoided, thereby avoiding a waste of system resources.

Corresponding to the foregoing method embodiments, the present application further provides embodiments of an apparatus, an electronic device, and a storage medium.

FIG. 8 is a schematic structural diagram of an electronic device according to an exemplary embodiment. Referring to FIG. 8, on a hardware level, the device includes a processor 801, a network interface 802, a memory 803, a non-volatile storage 804, and an internal bus 805. Of course, the device may further include hardware required for other functions. One or more embodiments of the present application may be implemented in a software-based manner, such as reading, by the processor 801, a corresponding computer program from the non-volatile storage 804 into the memory 803 and then running. Of course, in addition to the software implementation manner, one or more embodiments of the present application do not exclude other implementation manners, such as a manner of a logic device or a combination of software and hardware. That is to say, the execution subject of the following processing procedure is not limited to various logic units, and may also be a hardware or a logic device.

FIG. 9 is a service mesh configuration apparatus provided by an exemplary embodiment of the present application. The service mesh includes a central control plane component deployed in a central management and control device, a service mesh proxy component and at least one edge control plane component deployed in an edge cloud node, the edge control plane component is configured to manage at least one service mesh proxy component in an edge cloud node where the edge control plane component is located. The apparatus is applied to the central control plane component and includes:
a generating unit 902, configured to generate proxy configuration information for a target edge cloud node according to configuration requirement description information; and
an issuing unit 904, configured to issue the proxy configuration information to a resource scheduling cluster accessed by the target edge cloud node for the edge control plane component deployed on the target edge cloud node to issue, by monitoring the resource scheduling cluster, at least a part of monitored proxy configuration information to a service mesh proxy component managed by the edge control plane component.

In an implementation, the central control plane component maintains a preset corresponding relationship, and the preset corresponding relationship comprises a corresponding relationship between an edge cloud node and a resource scheduling cluster accessed by the edge cloud node.

The issuing unit 904 is specifically configured to: acquire a node identifier of the target edge cloud node carried in the configuration requirement description information, determine the resource scheduling cluster accessed by the target edge cloud node according to the preset corresponding relationship, and issue the proxy configuration information to the determined resource scheduling cluster.

In an implementation, in a case that the edge cloud node includes multiple copies of resources corresponding to multiple tenants, and each copy of resources is respectively accessed to different resource scheduling clusters, the preset corresponding relationship further includes a corresponding relationship between a tenant and a resource scheduling cluster.

The issuing unit 904 is specifically configured to: acquire the node identifier of the target edge cloud node carried in the configuration requirement description information and information about a target tenant that sends the configuration requirement description information; determine, according to the preset corresponding relationship, the resource scheduling cluster accessed by the target edge cloud node and corresponding to the target tenant; and issue the proxy configuration information to the determined resource scheduling cluster.

In an implementation, the target edge cloud node is all edge cloud nodes in a network system.

The issuing unit 904 is specifically configured to issue the proxy configuration information to a resource scheduling cluster accessed by all the edge cloud nodes in the network system.

In an implementation, the central control plane component maintains an authentication certificate of a resource cluster.

The issuing unit 904 is specifically configured to: generate, according to the resource scheduling cluster accessed by the target edge cloud node, proxy configuration information comprising an authentication certificate of a corresponding resource scheduling cluster for the resource scheduling cluster receiving the proxy configuration information to perform authentication based on the authentication certificate.

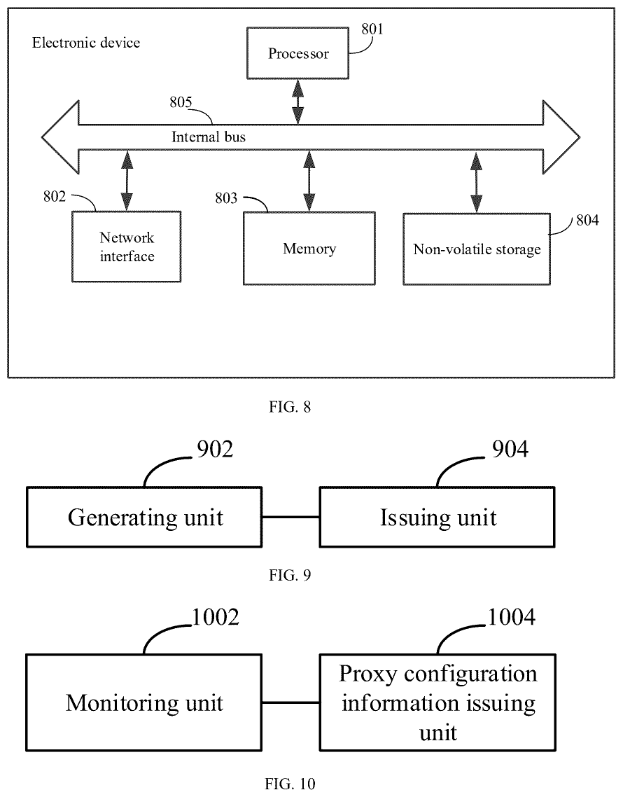

FIG. 10 is a service mesh configuration apparatus provided by an exemplary embodiment of the present application. The service mesh includes a central control plane component deployed in a central management and control device, a service mesh proxy component and at least one edge control plane component deployed in an edge cloud node, the edge control plane component is configured to manage at least one service mesh proxy component in an edge cloud node where the edge control plane component is located. The apparatus is applied to any edge control plane component and includes:
a monitoring unit 1002, configured to monitor a resource scheduling cluster accessed by an edge cloud node where the any edge control plane component is located; and
a proxy configuration information issuing unit 1004, configured to issue at least a part of monitored proxy configuration information to a service mesh proxy component managed by the any edge control plane component, where the proxy configuration information is generated by the central control plane component according to configuration requirement description information and issued to a resource scheduling cluster accessed by a target edge cloud node corresponding to the configuration requirement description information.

In an implementation, the proxy configuration information includes a node identifier of the target edge cloud node.

The proxy configuration information issuing unit 1004 is specifically configured to: select, according to a node identifier of the edge cloud node where the edge control plane component is located, proxy configuration information related to the edge cloud node where the edge control plane component is located from the monitored proxy configuration information, and issue the selected proxy configuration information to the at least one service mesh proxy component managed by the edge control plane component.

For the apparatus embodiments, since basically corresponding to the method embodiments, for the relevant description, reference may be made to partial description of the method embodiments. The apparatus embodiments described above are merely exemplary, where modules described as separate parts may or may not be physically separated, and parts displayed as modules may or may not be physical modules, i.e., may be located in one position, or may be distributed on a plurality of network modules. A part or all of the modules may be selected according to actual requirements to achieve the objectives of the solutions of the present application. A person of ordinary skill in the art can understand and implement without creative efforts.

In a typical configuration, a computer device includes one or more processors (CPUs), an input/output interface, a network interface, and a memory.

The memory may include a non-permanent storage in a computer-readable medium, a random-access memory (RAM), and/or a non-volatile memory, etc., such as a read-only memory (ROM) or a flash RAM. The memory is an example of the computer-readable medium.

The computer-readable medium, including both permanent and non-permanent, removable and non-removable media, may implement information storage by any method or technologies. The information may be computer-readable instructions, data structures, modules of a program, or other data. Examples of the computer storage medium include, but not limited to a phase-change random access memory (PRAM), a static random access memory (SRAM), a dynamic random access memory (DRAM), other types of a random access memory (RAM), a read-only memory (ROM), an electrically erasable programmable read-only memory (EEPROM), a flash memory or other memory technologies, a read-only compact disc read-only memory (CD-ROM), a digital versatile disc (DVD) or other optical storage, magnetic cassettes, magnetic tape magnetic disk storage or other magnetic storage devices, or any other non-transmission medium that may be used to store information that may be accessed by a computing device. As defined herein, the computer-readable medium does not include transitory computer-readable media (transitory media), such as modulated data signals and carrier waves.

It should also be noted that, terms “include”, “contain”, or any other variation thereof are intended to cover a non-exclusive inclusion, so that a process, a method, a commodity, or a device that includes a series of elements not only includes those elements, but also includes other elements that are not explicitly listed, or further includes inherent elements of the process, the method, the commodity, or the device. Without more limitations, an element limited by “include a . . . ” does not exclude other same elements existing in the process, the method, the commodity, or the device that includes the element.

Exemplary embodiments will be described in detail, with examples shown in the accompanying drawings. With regard to the description related to the accompanying drawings, unless stated otherwise, the same numbering in different drawings may represent the same or similar elements. The embodiments described in the following exemplary embodiments do not represent all embodiments consistent with the present application. On the contrary, they are merely examples of apparatuses and methods consistent with some aspects of the present application and the appended claims.

The terminology used in the present application is for the purpose of describing particular embodiments only and is not intended to be limiting of the present application. As used in the present application and the appended claims, the singular forms “a,” “the” and “this” are intended to include plural forms as well, unless the context clearly indicates otherwise. It should also be understood that the term “and/or” as used herein refers to and encompasses any or all possible combinations of one or more associated listed items.

It should be understood that although the terms first, second, third, etc., may be employed in the present application to describe various information, the information should not be limited by these terms. These terms are only used to distinguish the same type of information from each other. For example, first information may also be referred to as second information, and similarly, the second information may also be referred to as the first information, without departing from the scope of the present application. The word “if” as used herein may be construed as “when . . . ” or “in a case that . . . ” or “in response to . . . determining” which depends on the context.

The foregoing are merely preferred embodiments of the present application, but are not intended to limit the present application. Any modification, equivalent replacement, or improvement made without departing from the spirit and principle of the present application shall fall within the protection scope of the present application.

1. A network system, comprising: a central management and control device and at least one edge cloud node, wherein the central management and control device is deployed with a central control plane component, and each edge cloud node is deployed with a service mesh proxy component and at least one edge control plane component;
the central control plane component is configured to generate proxy configuration information for a target edge cloud node according to configuration requirement description information, and issue the proxy configuration information to a resource scheduling cluster accessed by the target edge cloud node; and
the edge control plane component is configured to manage at least one service mesh proxy component in an edge cloud node where the edge control plane component is located, and issue, by monitoring a resource scheduling cluster accessed by the edge cloud node where the edge control plane component is located, at least a part of monitored proxy configuration information to a service mesh proxy component managed by the edge control plane component.

2. The system according to claim 1, wherein the central control plane component maintains a preset corresponding relationship, and the preset corresponding relationship comprises a corresponding relationship between an edge cloud node and a resource scheduling cluster accessed by the edge cloud node;
the central control plane component is specifically configured to acquire a node identifier of the target edge cloud node carried in the configuration requirement description information, determine the resource scheduling cluster accessed by the target edge cloud node according to the preset corresponding relationship, and issue the proxy configuration information to the determined resource scheduling cluster.

3. The system according to claim 2, wherein in a case that the edge cloud node comprises multiple copies of resources corresponding to multiple tenants, and each copy of resources is respectively accessed to different resource scheduling clusters, the preset corresponding relationship further comprises a corresponding relationship between a tenant and a resource scheduling cluster;
the central control plane component is specifically configured to acquire the node identifier of the target edge cloud node carried in the configuration requirement description information and information about a target tenant that sends the configuration requirement description information; determine, according to the preset corresponding relationship, the resource scheduling cluster accessed by the target edge cloud node and corresponding to the target tenant; and issue the proxy configuration information to the determined resource scheduling cluster.

4. The system according to claim 1, wherein the target edge cloud node is all edge cloud nodes in the network system;
the central control plane component is specifically configured to issue the proxy configuration information to a resource scheduling cluster accessed by all the edge cloud nodes in the network system.

5. The system according to claim 1, wherein the proxy configuration information comprises a node identifier of the target edge cloud node;
the edge control plane component is specifically configured to select, according to a node identifier of the edge cloud node where the edge control plane component is located, proxy configuration information related to the edge cloud node where the edge control plane component is located from the monitored proxy configuration information, and issue the selected proxy configuration information to the at least one service mesh proxy component managed by the edge control plane component.

6. The system according to claim 1, wherein the central control plane component maintains an authentication certificate of a resource cluster;
the central control plane component is specifically configured to: generate, according to the resource scheduling cluster accessed by the target edge cloud node, proxy configuration information comprising an authentication certificate of a corresponding resource scheduling cluster for the resource scheduling cluster receiving the proxy configuration information to perform authentication based on the authentication certificate.

7. The system according to claim 1, wherein the edge cloud node is further deployed with a service discovery component, and the service discovery component is configured to manage an address of the edge control plane component deployed in the edge cloud node where the service discovery component is located;
the service mesh proxy component is specifically configured to acquire, after being started, an address of an edge control plane component had been deployed in the edge cloud node where the service mesh proxy component is located by querying the service discovery component, and establish a connection with an edge control plane component corresponding to any address.

8. A service mesh configuration method, wherein the service mesh comprises a central control plane component deployed in a central management and control device, a service mesh proxy component and at least one edge control plane component deployed in an edge cloud node, the edge control plane component is configured to manage at least one service mesh proxy component in an edge cloud node where the edge control plane component is located; and the method is applied to the central control plane component and comprises:
generating proxy configuration information for a target edge cloud node according to configuration requirement description information; and
issuing the proxy configuration information to a resource scheduling cluster accessed by the target edge cloud node for the edge control plane component deployed on the target edge cloud node to issue, by monitoring the resource scheduling cluster, at least a part of monitored proxy configuration information to a service mesh proxy component managed by the edge control plane component.

9. The method according to claim 8, wherein the central control plane component maintains a preset corresponding relationship, and the preset corresponding relationship comprises a corresponding relationship between an edge cloud node and a resource scheduling cluster accessed by the edge cloud node; and the issuing the proxy configuration information to the resource scheduling cluster accessed by the target edge cloud node comprises:
acquiring a node identifier of the target edge cloud node carried in the configuration requirement description information, determining the resource scheduling cluster accessed by the target edge cloud node according to the preset corresponding relationship, and issuing the proxy configuration information to the determined resource scheduling cluster.

10. The method according to claim 9, wherein in a case that the edge cloud node comprises multiple copies of resources corresponding to multiple tenants, and each copy of resources is respectively accessed to different resource scheduling clusters, the preset corresponding relationship further comprises a corresponding relationship between a tenant and a resource scheduling cluster; and the issuing the proxy configuration information to the resource scheduling cluster accessed by the target edge cloud node comprises:
acquiring the node identifier of the target edge cloud node carried in the configuration requirement description information and information about a target tenant that sends the configuration requirement description information; determining, according to the preset corresponding relationship, the resource scheduling cluster accessed by the target edge cloud node and corresponding to the target tenant; and issuing the proxy configuration information to the determined resource scheduling cluster.

11. The method according to claim 8, wherein the target edge cloud node is all edge cloud nodes in a network system, and the issuing the proxy configuration information to the resource scheduling cluster accessed by the target edge cloud node comprises:
issuing the proxy configuration information to a resource scheduling cluster accessed by all the edge cloud nodes in the network system.

12. A service mesh configuration method, wherein the service mesh comprises a central control plane component deployed in a central management and control device, a service mesh proxy component and at least one edge control plane component deployed in an edge cloud node, the edge control plane component is configured to manage at least one service mesh proxy component in an edge cloud node where the edge control plane component is located; the method is applied to any edge control plane component and comprises:
monitoring a resource scheduling cluster accessed by an edge cloud node where the any edge control plane component is located; and
issuing at least a part of monitored proxy configuration information to a service mesh proxy component managed by the any edge control plane component, wherein the proxy configuration information is generated by the central control plane component according to configuration requirement description information and issued to a resource scheduling cluster accessed by a target edge cloud node corresponding to the configuration requirement description information.

13. A non-transitory computer-readable storage medium, on which a computer program is stored, wherein a processor, when executing the program, is configured to perform steps of the method according to claim 8.

14. An electronic device, comprising a memory, a processor and a computer program stored in the memory and capable of running on the processor, wherein the processor, when executing the program, is configured to perform steps of the method according to claim 8.

15. The non-transitory computer-readable storage medium according to claim 13, wherein the central control plane component maintains a preset corresponding relationship, and the preset corresponding relationship comprises a corresponding relationship between an edge cloud node and a resource scheduling cluster accessed by the edge cloud node; and the processor is configured to perform the following operations:
acquiring a node identifier of the target edge cloud node carried in the configuration requirement description information, determining the resource scheduling cluster accessed by the target edge cloud node according to the preset corresponding relationship, and issuing the proxy configuration information to the determined resource scheduling cluster.

16. The non-transitory computer-readable storage medium according to claim 15, wherein in a case that the edge cloud node comprises multiple copies of resources corresponding to multiple tenants, and each copy of resources is respectively accessed to different resource scheduling clusters, the preset corresponding relationship further comprises a corresponding relationship between a tenant and a resource scheduling cluster; and the processor is configured to perform the following operations:
acquiring the node identifier of the target edge cloud node carried in the configuration requirement description information and information about a target tenant that sends the configuration requirement description information; determining, according to the preset corresponding relationship, the resource scheduling cluster accessed by the target edge cloud node and corresponding to the target tenant; and issuing the proxy configuration information to the determined resource scheduling cluster.

17. A non-transitory computer-readable storage medium, on which a computer program is stored, wherein a processor, when executing the program, is configured to perform steps of the method according to claim 12.

18. The electronic device according to claim 14, wherein the central control plane component maintains a preset corresponding relationship, and the preset corresponding relationship comprises a corresponding relationship between an edge cloud node and a resource scheduling cluster accessed by the edge cloud node; and the processor is configured to:
acquire a node identifier of the target edge cloud node carried in the configuration requirement description information, determine the resource scheduling cluster accessed by the target edge cloud node according to the preset corresponding relationship, and issue the proxy configuration information to the determined resource scheduling cluster.

19. The electronic device according to claim 18, wherein in a case that the edge cloud node comprises multiple copies of resources corresponding to multiple tenants, and each copy of resources is respectively accessed to different resource scheduling clusters, the preset corresponding relationship further comprises a corresponding relationship between a tenant and a resource scheduling cluster; and the processor is configured to:
acquire the node identifier of the target edge cloud node carried in the configuration requirement description information and information about a target tenant that sends the configuration requirement description information; determine, according to the preset corresponding relationship, the resource scheduling cluster accessed by the target edge cloud node and corresponding to the target tenant; and issue the proxy configuration information to the determined resource scheduling cluster.

20. An electronic device, comprising a memory, a processor and a computer program stored in the memory and capable of running on the processor, wherein the processor, when executing the program, is configured to perform steps of the method according to claim 12.
